(19) United States
(12) Patent Application Publication
(10) Pub. No.: US 2004/0172401 A1
(43) Pub. Date: Sep. 2, 2004

(54) Significance testing and confidence interval construction based on user-specified distributions

(76) Inventor: Terrence B. Peace, Victoria (CA)

Correspondence Address: GREENBLUM & BERNSTEIN, P.L.C., 1950 ROLAND CLARKE PLACE, RESTON, VA, 20191, US

(21) Appl. No.: 10/626,668

(22) Filed: Jul. 25, 2003

Related U.S. Application Data
(63) Continuation-in-part of application No. 09/594,144, filed on Jun. 15, 2000.

(51) Int. Cl. G06F 7/00

(52) U.S. Cl. 707/100

(57) ABSTRACT

A computer implemented method and program for analyzing statistical an original data set having a first size, dimension and distribution. Multiple random data sets are generated, each having a second size, dimension and distribution related to the first size, dimension and distribution of the original data set. Numerical values of test statistics corresponding to the random data sets are calculated in accordance with a predetermined test statistic formula. A relationship between the numerical values corresponding to the random data sets and the numerical value of the test statistic corresponding to the random data set, calculated in accordance with the test statistic formula, is determined. It is determined that the original data set includes at least one factor not based on chance when the relationship indicates that the numerical value of the original test statistic is not within a range of the numerical values corresponding to the random data sets.

This application is a continuation-in-part of U.S. patent application Ser. No. 09/594,144, filed Jun. 15, 2000, the contents of which is expressly incorporated by reference herein in its entirety.

### BACKGROUND OF THE INVENTION

1. Field of the Invention

The present invention relates to the analysis of statistical data, preferably on a computer and using a computer implemented program. The invention more specifically relates to a method and apparatus that accurately analyzes statistical data when that data is not normally distributed, by which is meant distributed according to a normal or Guassian distribution, nor distributed according to some other typically used probability distribution, such as Poisson distribution, whether these distributions are univariate or multivariate, or whether these terms refer to marginal distributions.

2. Description of the Prior Art

Conventional data analysis involves the testing of statistical hypotheses for validation. The usual method for testing these hypotheses, in most situations, is based on the well known “General Linear Model,” which produces valid results only if the data are either normally distributed or approximately so.

Where the data set to be analyzed is not “normally” distributed, or not distributed according to the assumptions of the statistical procedure in use, the known practice is to transform the data by non-linear transformation to comply with the distributional assumptions of the statistical procedure. This practice is disclosed in, for example, Haglin, Mosteller, Tukey, UNDERSTANDING ROBUST AND EXPLORATORY DATA ANALYSIS (1977), the contents of which are expressly incorporated by reference herein in their entirety.

It was previously thought that data could be transformed to comply with known distributional assumptions without affecting the integrity of the analysis. More recent research has demonstrated, however, that the practice of non-linear transformation actually introduces unintended and significant error into the analysis. See, e.g., Terrence B. Peace, Ph.D, TRANSFORMATION AND CORRLATION (2000) and TRANSFORMATION AND T-TEST (2000), the contents of which are expressly incorporated by reference herein in their entirety. A solution to this problem is needed. The subject invention therefore provides a method and apparatus capable of evaluating statistical data and outputting reliable analytical results without relying on transformation techniques.

U.S. Pat. No. 5,893,069 to White, Jr., entitled “System and method for testing prediction model,” discloses a computer implemented statistical analysis method to evaluate the efficacy of prediction models as compared to a “benchmark” model. White discloses the “bootstrap” method of statistical analysis in that it randomly generates data sets from the empirical data set itself.

### SUMMARY OF THE INVENTION

It is therefore an object of the invention disclosed herein to provide a computer and a computer implemented method and program, which more accurately analyzes statistical data distributed non-normally.

It is another object of the instant invention to provide a computer and computer implemented method and program by which statistical data can be analyzed under virtually any distributional assumptions, including normality.

It is yet another object of the invention to provide a method and apparatus to analyze said data without transforming the naturally occurring distribution of the original data into a Normal distribution, a Poisson distribution, or the like, thereby avoiding errors which transformation may introduce into the analysis, said transformation preceding traditional data analysis techniques.

It is another object of the invention to enable and otherwise enhance sensitivity analysis to cross-check results of the analysis.

It is a further object of the present invention to provide a method and apparatus for the analysis of statistical data for use in various disciplines which rely in whole or part on statistical data analysis and forecasts, including, for example, finance, exchange, trading, marketing, economics, materials, administration and medical research.

It is an additional object of the present invention to provide a method and apparatus of statistical analysis which enable the user to construct new test statistics, rather than rely on those test statistics with distributions that have already been determined. The subject invention removes this restriction so that any function of the data may be used as a test statistic.

It is a further object of the present invention to provide a method and apparatus for statistical analysis that enables the user to make inferences on multiple parameters simultaneously. The instant invention will permit all aspects of more than one distribution to be tested one against the other in a single analysis and determine significant differences, if any exist.

Yet another object of the present invention is to provide a method and apparatus that enables a user to perform sensitivity analysis on the inference procedure while using all of the underlying data.

These and other objects will become readily apparent to a person of skill in the art having regard for this disclosure.

The invention achieves the above objects by providing a technique to analyze empirical data within its original distribution rather than transforming it to a Normal or Gaussian distribution, for example. It is preferably implemented using a digital processing computer, and therefore a computer, as well as a method and program to be executed by a digital processing computer, is contemplated. The technique comprises, in part, the computer generating numerous random or pseudo-random data sets having substantially the same size and dimension as the original data set, with a distribution defined to best describe the process which generated the original data set. Functions of these randomly generated data sets are compared to a corresponding function of the original data set to determine the likelihood of such a value arising purely by chance. One embodiment of the invention requires input from the user defining a number of options, although alternative embodiments of the invention would involve the computer determining options at predetermined stages in the analysis. The method and program disclosed herein is superior in that it allows data to be analyzed more accurately and efficiently, permits the data to be analyzed in accordance with any distribution (including the distribution which generated the data), avoids the errors which may be introduced by data transformation, permits the use of any function of the data as a test statistic, and facilitates sensitivity analysis.

An aspect of the present invention provides a method for testing validity of a prediction model based on an original data set. The method includes specifying a test statistic formula, computing a numerical value NTS of the test statistic using the test statistic formula and the original data set, and specifying a probability distribution relating to the original data set. The test statistic may include a function of prediction error. Also, a confidence interval may be constructed for the test statistic.

Random data sets RDB(i) are created using randomly generated data, in which i is a positive integer. Numerical values TS(i) of the test statistic are computed corresponding to the random data sets RDB(i), and stored in a numerical test statistic array. The numerical value NTS is compared with the numerical test statistic array to determine a non-empty set of percentile values corresponding to the numerical value NTS and an associated non-empty set of percentile indices. Each of the data sets RDB(i) may be distributed according to the probability distribution. Also, each of the data sets RDB(i) may have a size that is functionally equivalent to a size of the original data set, and/or the same size, dimension and distribution as the original data set.

The method for testing validity of a prediction model may further include determining a null hypothesis defining a potential relationship among data in the original data set. The null hypothesis is rejected as not accurately representing the original data set when the value of a function of the non-empty set of percentile indices, associated with the non-empty set of percentile values, which correspond to the numerical value NTS, is in an extreme range, indicating that the numerical value NTS did not arise by chance. For example, the extreme range may include one above a 97.5^{th} percentile and below a 2.5^{th} percentile. Also, the function of percentile indices may be a linear combination of the non-empty set of percentile indices.

The non-empty set of percentile values may include the greatest percentile value less than NTS and the smallest percentile value greater than NTS, and the non-empty set of percentile indices may include the two percentile indices corresponding to the two percentile values of the non-empty set of percentile values. Alternatively, one percentile index may be selected, when the corresponding percentile value meets a predetermined criterion for proximity to the numerical value NTS of the test statistic corresponding to the original data set.

Another aspect of the present invention provides a computing apparatus for analyzing an original data set, having a first size, dimension and distribution. The computing apparatus includes a computing device for executing computer readable code; an input device for receiving data, the input device being in communication with the computing device; at least one data storage device for storing computer data, the data storage device being in communication with the computing device; and a programming code reading device that reads computer executable code, the programming code reading device being in communication with the computing device. The computer executable code causes the computing device to generate random data sets, each having a second size, dimension and distribution relating to the original data set. Numerical values of test statistics corresponding to the random data sets are calculated, according to a test statistic formula. A relationship is determined between the numerical values and the numerical value of the test statistic corresponding to the original data set, calculated in accordance with the test statistic formula. The second size, dimension and distribution may be the same as the first size, dimension, and distribution.

Another aspect of the present invention provides a computer readable medium storing a computer program that determines a likelihood of at least one factor in an original data set not arising by chance, in accordance with a predetermined test statistic formula. The original data set has a first size, dimension and distribution. The program includes a calculating source code segment, a comparing source code segment and a determining source code segment. The calculating source code segment calculates numerical values of test statistics corresponding to randomly generated data sets, calculated in accordance with the predetermined test statistic formula. Each randomly generated data set has a second size, dimension and distribution relating to the original data set. The comparing source code segment compares a numerical value of a test statistic calculated in accordance with the predetermined test statistic formula and calculated with the original data set, with the numerical values corresponding to the randomly generated data sets. The determining source code segment determines that at least one factor in the original data set did not arise by chance when the numerical value of the test statistic calculated from the original data set is not within a range, within the numerical values corresponding to the randomly generated data sets, representative of numerical values arising by chance. The second size, dimension and distribution may be the same as the first size, dimension and distribution.

The program may further include a percentile determining source code segment that determines percentile values, based on the numerical values, and percentile indices, corresponding to the percentile values. The comparing source code segment compares the numerical value of the test statistic corresponding to the original data set with the numerical values corresponding to the randomly generated data sets by determining a non-empty set of selected percentile indices from the plurality of percentile indices corresponding to the random data sets associated with a non-empty set of the percentile values from the percentile values which meets a predetermined criterion for proximity to the numerical value of the test statistic corresponding to the original data set.

The various aspects and embodiments of the present invention are described in detail below.

### BRIEF DESCRIPTION OF THE DRAWINGS

The invention is illustrated in the figures of the accompanying drawings, which are meant to be exemplary and not limiting:

FIG. 1 is a schematic diagram of the hypothesis testing evaluation system;

FIG. 2a and FIG. 2b depict a flow chart showing the steps for executing the hypothesis testing method and program; and

FIG. 3 is a flow chart showing the steps for executing the hypothesis testing method and program in which the hypothesis is replaced by a confidence interval.

### DETAILED DESCRIPTION OF INVENTION

As discussed above, the present invention supplies a computer and appropriate software or programming that more accurately analyzes statistical data when that data is not distributed according to the assumptions of the procedure, such as not “normally distributed.” The invention therefore provides a method and apparatus for evaluating statistical data and outputting reliable analytical results without relying on traditional prior art transformation techniques, which introduce error. The practice of the present invention results in several unexpectedly superior benefits over the prior art statistical analyses.

First, it enables the user to construct new and possibly more revealing test statistics, rather than relying on those test statistics with distributions that have already been determined. For example, the “t-statistic” is often used to test whether two samples have the same mean. The numerical value of the t-statistic is calculated and then related to tables that had been prepared using a knowledge of the distribution of this test statistic. Prior to the subject invention, a test statistic has been useless until its distribution has been discovered; thus, for all practical purposes, the number of potential test statistics has been relatively small. The subject invention removes this restriction; any function of the data may be used as a test statistic. As used herein, the term “test statistic” refers to any function of the data, including, for example, functions used for description, such as the correlation coefficient, for significance testing, such as the t-test statistic, for prediction, such as the ARIMA coefficients, for functions of the predicted quantities themselves, and for functions of error.

Second, the invention enables the user to make inferences on multiple parameters simultaneously. For example, suppose that the null hypothesis (to be disproved) is that two data distributions arising from two potentially related conditions are the same. Traditional data analysis might reveal that the two means are not quite significantly different, nor are the two variances. The result is therefore inconclusive; no formal test exists within the general linear model to determine if the two distributions are different and that this difference is statistically significant. The present invention will permit all aspects of both distributions to be tested one against the other in a single analysis and determine significant differences, if any exist.

Third, sensitivity analysis is a natural extension of the data analysis under the invention, whereas sensitivity analysis is extremely difficult and impractical using current methods and software. Sensitivity analysis examines the effect on conclusions of small changes in the assumptions. For example, if the assumption is that the process that generated the data is a Beta (2,4), then a repeat analysis under a slightly different assumption (e.g. Beta (2,5)) should not produce a markedly different result. If it does, conclusions obtained from the initial assumption should be treated with caution. Such sensitivity analysis under the invention is simple and is suggested by the method itself.

U.S. Pat. No. 5,893,069 to White discloses a computer implemented statistical analysis method to evaluate the efficacy of prediction models as compared to a “benchmark” model. However, the invention disclosed herein is superior to this prior art in that it tests the null hypothesis against entirely independent, randomly-generated data sets having the same size and dimension as the original data set, with a distribution defined to best describe the process which generated the original data set under the null hypothesis.

The present invention is remarkably superior to that of White, in that the present invention enables the evaluation of an empirically determined value of the test statistic by comparison to an unadulterated, randomly produced vector of values of that test statistic. Under the disclosed invention, when the empirical test statistic falls within an extreme random-data-based range of values (e.g. above the 95^{th} percentile or below the 5^{th} percentile), the null hypothesis which is being tested can be rejected as false, with a high level of confidence that is not merited in the prior art with respect to non-normal data distributions. Therefore, the ability is greatly enhanced to determine accurately whether certain factors are significantly interrelated or whether certain populations are significantly different.

Statistical hypothesis testing is the basis of much statistical inference, including determining the statistical significance of regression coefficients and of a difference in the means. A number of important problems in statistics can be reduced to problems in hypothesis testing, which can be analyzed using the disclosed invention. One example is determining the likelihood ratio L, which itself is an example of a test statistic. When formulated so that the likelihood ratio is less than one, then the null hypothesis is rejected when the likelihood ratio is less than some predetermined constant k. When the constant k is weighted by the so-called prior probabilities of Bayes Theory, the disclosed invention encompasses Bayesian analyses as well. As related to the disclosed invention, the likelihood ratio may be generalized so that different theoretical distributions are used in the numerator and denominator.

Also, the likelihood ratio or its generalization may be invoked repeatedly to solve a multiple decision problem, in which more than two hypotheses are being tested. For example, in the case of testing an experimental medical treatment, the standard treatment would be abandoned only if the new treatment were notably better. The statistical analysis would therefore produce three relevant possibilities: an experimental treatment that is much worse, much better or about the same as the standard treatment, only one of which would result in rejection of the standard treatment. These types of multiple decision problems may be solved using the disclosed invention by the repeated use of the likelihood ratio as the test statistic.

Prediction problems may also be analyzed, whether predicting future events from past observations of the same events (e.g. time series analysis), or predicting the value of one variable from observed values of other variables (e.g. regression), or some combination of the two. The test statistics in this case would often be the prediction model's parameters, such as ARIMA coefficients. The statistical significance of the prediction model's performance, meaning the likelihood that the model would predict to the same level of accuracy due only to chance, may also be estimated.

One way to evaluate time series prediction models is to predict the final observation from those observations which precede it. Thus, given a time series of n observations, a prediction model would be derived from the first n−1 observations, and the success of the model would be judged on how well the final observation was predicted. The difference between the final observation and the value which was predicted is the error. Functions of error, such as the squared error, may also be useful. Because the error, or a function of the error, is itself a function of the data, and therefore a test statistic, this method of evaluating time series prediction models is compatible with the disclosed method and program. An analogous method may be used to evaluate models which predict the value of one variable from values of other variables, and also to evaluate models which are a mixture of the two types. In some practical situations, it is desirable to make predictions using only the most recent part of the data set, e.g., after a certain number of observations, in which case the same considerations apply. The disclosed method and program may also be used in these cases and, in most practical situations, will prove to be superior.

The instant invention may also be used to determine confidence intervals, which is a closely related statistical device. Whereas hypothesis testing begins with the numerical value of the test statistic and derives the respective probability, a confidence interval begins with a range of probabilities and derives a range of possible corresponding numerical values of the test statistic. A common confidence interval is the 95 percent confidence interval, and ranges between the two percentiles P2.5 and P97.5. Given the symmetrical relation of the two techniques, there would be nearly identical methods of calculation. A slight modification of the disclosed method, which is obvious to those skilled in the art, enables the user to construct confidence intervals as opposed to test hypotheses, with a greater level of accuracy.

Thus, this invention relates to determining the likelihood of a statistical observation given particular statistical requirements. It can be used to determine the efficacy of statistical prediction models, the statistical significance of hypotheses, and the best of several hypotheses under the multiple decision paradigm, as well as to construct confidence intervals, all without first transforming the data into a “normal” distribution. It is most preferably embodied on a computer, and is a method to be implemented by computer and a computer program that accomplishes the steps necessary for statistical analysis. Incorporation of a computer system is most preferred to enable the invention.

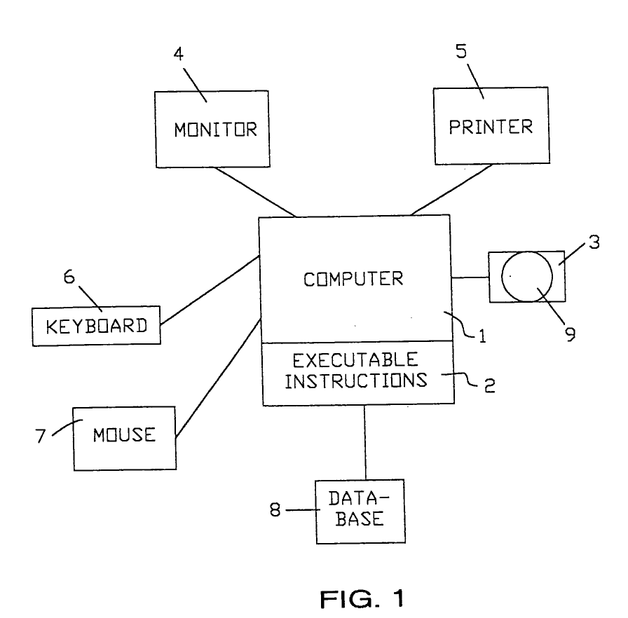

Referring to FIG. 1, the computer system includes a digital processing apparatus, such as a computer or central processing unit 1, capable of executing the various steps of the method and program. In the one embodiment, the computer 1 is a personal computer, workstation or server known to those skilled in the art, such as those manufactured by IBM, Dell Computer Corporation, Hewlett Packard and Apple. Any corresponding operating system may be involved, such as those sold under the trademarks “Windows” or “Unix.” Other embodiments include networked computers, notebook computers, handheld computing devices and any other microprocessor-driven device capable of executing the steps disclosed herein.

As shown in FIG. 1, the computer includes the set of computer-executable instructions 2, in computer readable code, that encompass the method or program disclosed herein. The instructions may be stored and accessible internally to the computer, such as in the computer's RAM, conventional hard disk drive, or any other executable data storage medium. Alternatively, the instructions may be contained in an external data storage device 3 compatible with a computer readable medium, such as a floppy diskette 9, magnetic tape, compact disk, DVD or memory chips compatible with and executable by the computer 1.

The system can include peripheral computer equipment known in the art, including output devices, such as a video monitor 4 and printer 5, and input devices, such as a keyboard 6 and a mouse 7. Embodiments of the invention contemplate any peripheral equipment available to the art. Additional potential output devices include other computers, audio and visual equipment and mechanical apparatus. Additional potential input devices include scanners, facsimile devices, trackballs, keypads, touch screens and voice recognition devices.

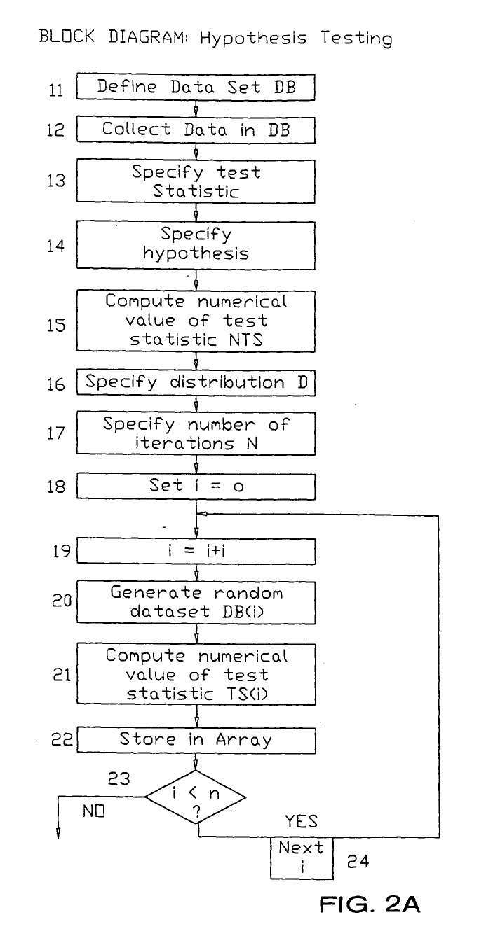

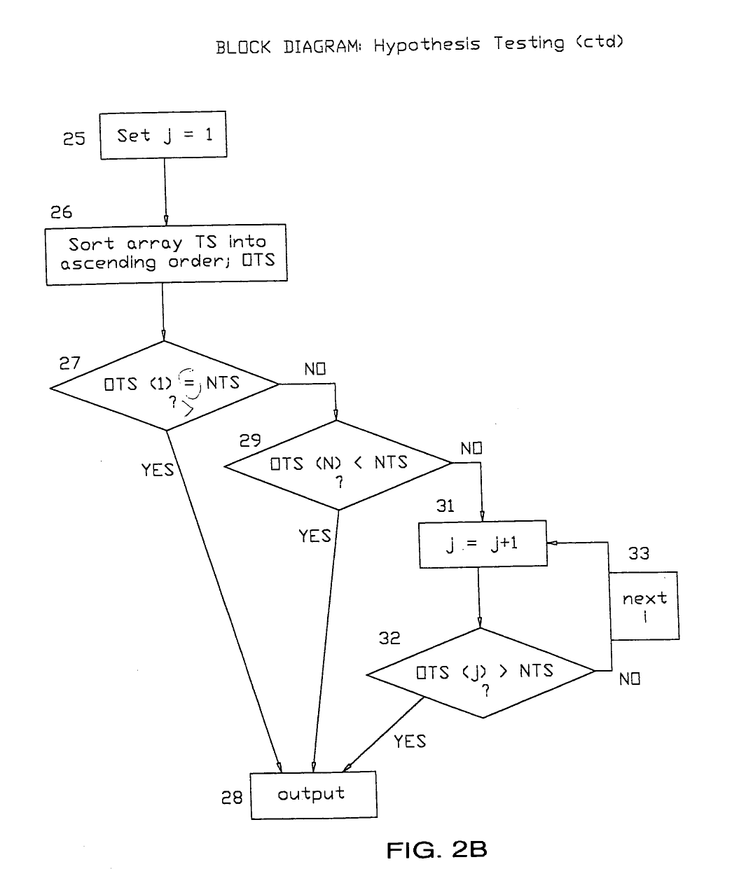

The computer executable instructions 2 begin by defining the structure of data set DB at step 11 of FIG. 2a, a flowchart of the computer executable steps. The original data to be analyzed is collected into the data set at step 12. This original data introduced at step 12 may consist of known empirical data; theoretical, hypothetical or other synthetically generated data; or any combination thereof. The original data set is stored as a computer accessible database 8 of FIG. 1. The database 8 can be internal to or remote from the computer 1. The database 8 can be input onto the computer accessible medium in any fashion desired by the user, including manually typing, scanning or otherwise downloading the database.

Referring to FIG. 2a, the user specifies a test statistic at step 13 and specifies a formal hypothesis at step 14 in terms of said test statistic, in most practical cases known as the null hypothesis, concerning the data set DB. The term test statistic is used to denote a function of the data that will be used to test the hypothesis. The terms “numerical value of the test statistic” and “numerical test statistic” denote a particular value calculated by using that function on a given data set. Determination of a test statistic may be accomplished by known means. See, for example P. G. Hoel, S. C. Port & C. J. Stone, INTRODUCTION TO STATISTICAL THEORY (1971), the contents of which are expressly incorporated by reference herein in their entirety.

Examples of test statistics include a two sample t-statistic, which is approximately distributed as the “Student's t-distribution” under fairly general assumptions, the Pearson product-moment correlation coefficient r, and the likelihood ratio L. Embodiments of the invention include computing the numerical values of several test statistics simultaneously, in order to test compound hypotheses or to test several independent hypotheses at the same time.

Embodiments of the invention may include test statistics known in the art to be previously input to the computer and stored in computer accessible database 2, either internal to or remote from the computer 1. Specifying a test statistic at step 13 of FIG. 2a may then be accomplished by the user, when prompted in the course of program execution, selecting from the test statistic database. Likewise, the computer 1 may include executable instructions to select the test statistic from the database of test statistics. It is also contemplated that the user might define their own test statistic.

The hypothesis at step 14, specified in terms of said test statistic from step 13, may take several forms. Embodiments of this invention encompass any form of statistical problem that can be defined in terms of a hypothesis. In the disclosed embodiment of the invention, the formal hypothesis could be a “null hypothesis” addressing, for example, the degree to which two variables represented in the original data set DB are interrelated or the degree to which two variables have different means. However, the formal hypothesis may also take any form alternative to a null hypothesis.

For example, the hypothesis may be a general hypothesis arising from a multiple decision problem, which results in the original data falling within one of three alternative possibilities. Regardless of the form, the hypothesis represents the intended practical application of the computer and computer executable program, including testing the validity of prediction models and comparing results of experimental versus conventional medical treatments.

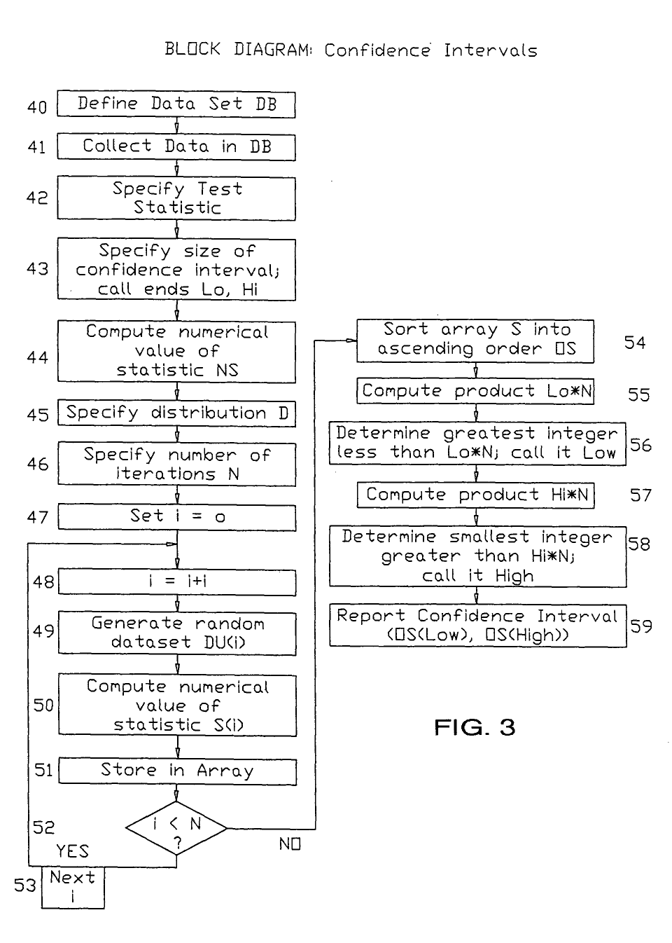

Using the original data set DB, the computer determines the numerical value NTS of the test statistic from the data set, as indicated in step 15 of FIG. 2a. Confidence intervals may also be constructed by a similar technique embodied by this invention, as indicated in FIG. 3. The primary difference between FIGS. 2a-2b and FIG. 3 relate to the interchanged roles of test statistic and probability: In hypothesis testing the probability is derived from the numerical value of the test statistic, while in confidence interval determination, a range of possible numerical values of the test statistic is derived from probabilities. Otherwise, the basic underlying novel concept is the same.

The disclosed invention may be seen more clearly by reference to step 16 of FIG. 2a (and step 45 of FIG. 3). In one embodiment, the user specifies the probability distribution in step 16 that describes the original data set DB under the null hypothesis of step 14. This distribution is the one from which the user theorizes the data may have arisen under the hypothesis of step 14. Conventional data analysis usually specifies the normal probability distribution, but under the disclosed invention, any distribution of data may be used to test hypothesis of step 14. One may appropriately specify the probability distribution from various considerations, such as theory, prior experimentation, the shape of the data's marginal distributions, intuition, or any combination thereof. Exemplary types and application of common probability distributions of statistical data sets are set forth and described in detail in various texts, including by way of example N. L. Johnson & S. Kotz, DISTRIBUTIONS IN STATISTICS, Vols. 1-3 (1970), the contents of which are expressly incorporated by reference herein in their entirety.

Embodiments of the invention include the realm of statistical distributions known in the art to be previously input to the computer and stored in computer accessible data set 8 of FIG. 1, either internal to or remote from the computer 1. The step in block 16 of specifying a distribution may then be performed by the computer based on its analysis of the original data set. In an embodiment, the computer determines the empirical distribution, with or without reference to distributions which have been previously studied. The empirical determination may be performed by any known technique, including, for example, sorting into bins along one or more dimensions. Alternatively, the user may specify the distribution by selecting from among the previously stored database of options, or defining any other distribution, including those not previously studied.

As shown in the next step 17 of FIG. 2a, the number of iterations N to be performed by the computer in analyzing the hypothesis 14 is specified. This is an integer that, in the disclosed embodiment, would be no less than 1,000. The invention contemplates any number of iterations, the general rule being that the accuracy of testing the hypothesis of step 14 increases with the number of iterations N. Factors affecting determination of N include the capabilities of computer 1, including processor speed and memory capacity. The computer then initializes variable i, setting it to zero in step 18. This variable will correspond to one of the randomly populated data sets addressed in subsequent steps.

In an embodiment of the invention, beginning at step 19, the computer then enters a repetitive loop of generating data for purposes of comparing and analyzing the original data set. The loop begins on each iteration with incrementing integer i by one. The computer then generates a set of random data RDB(i) at step 20 having the same structure, size and dimension as the original data set, with a distribution defined to best describe the process which generated the original data set under the null hypothesis of step 14.

In alternative embodiments, the size of the random data sets is not identical to the size of the original data set. Rather, the random data sets may be of sufficient size to be functionally equivalent to the size of the original data set, meaning that the error introduced by this change in size is acceptable in the context of the practical statistical problem to be addressed, without departing from the scope and spirit of the present invention. Of course, the size of the random data sets are consistent with the null hypothesis. When the number of data points in each of the random data sets is greater or less than the number of data points of the original data set, error may be introduced into the analysis. However, when the number of data points in the original data set is large, a lesser number of data points could be specified for the random data sets, such that the error introduced by using fewer data points is acceptable, while there would be useful economies of computing resources in generating and using the smaller random data sets.

The computer generates the random data using any technique known to the art that approximates truly random results (e.g., pseudo-random data). One embodiment of the invention incorporates the so-called Monte Carlo technique, which is described in the published text G. S. Fishman, MONTE CARLO—CONCEPTS, ALGORITHMS AND APPLICATIONS (1995), the contents of which are expressly incorporated by reference herein in their entirety.

Similarly, the dimension of the random data sets may be varied without departing from the scope and spirit of the present invention. For example, when a subset of the original data set is analyzed separately, the subset becomes the “original data set” for purposes of the invention. Similarly, the random data sets may have a dimension higher than the dimension of the original data set, such that the structure of the original data set appears embedded in a higher dimensional entity. Also, various combinations of restriction into subsets and expansion into supersets may be desired. In all cases, though, the dimension of the random data sets must be consistent with the null hypothesis.

With respect to distribution, it is understood that the notion of an empirical distribution is imprecise, in that an infinite number of observations is needed to unambiguously identify a theoretical probability distribution. Therefore, the empirical distribution of data (being finite) could be the maximum likelihood realization of any of a family of theoretical distributions. Further, maximum likelihood is not the only criterion for similarity of distributions. Therefore, for describing the invention, the distribution of the random data sets is understood to be any of the family of distributions that could reasonably be used to effectively describe the empirical distribution of the original data set. Again, the distribution of the random data sets must be consistent with the null hypothesis. More succinctly, the random data sets will be described as having “the same size, dimension and distribution as the original data set,” which is understood to include and subsume all of the considerations and variations of the previous discussion.

Using this randomly generated data set, the computer determines at step 21 a corresponding numerical value TS(i) of the test statistic, which is one example of a test statistic value that might arise at random under the null hypothesis 14, distributed as the distribution of step 16. This numerical value is stored in a numerical test statistic array at step 22.

At decision diamond 23, the computer compares i with the value N to determine whether they are yet equal to one another. If i is still less than N, the computer returns to the beginning of the repetitive loop as shown in step 24 and increments variable i by one at step 19. The computer then generates another set of random data RDB(i) at step 20 of the same size, dimension and distribution as the original data set. Using this randomly generated data set, the computer again determines at step 21 a corresponding numerical value TS(i) of the test statistic and stores TS(i) in the numerical test statistic array at step 22. This process is repeated until the computer determines that i equals N at the conclusion of the repetitive loop at decisional diamond 23. At that time, the computer will have stored an array consisting of N numerical values of the test statistic derived from randomly generated data sets.

After the computer has stored an array of randomly generated numerical test statistics, it must determine where among them falls the numerical test statistic NTS corresponding to the original data set. In this process, the value of the data dependent statistic, e.g. the median or 50^{th} percentile, will be referred to as the “percentile value P” and the ordinal number that defines the percentile, e.g. the 95^{th} in 95^{th} percentile, will be referred to as the “percentile index p.” More specifically, the computer must determine a percentile value P corresponding to NTS, so that the percentile index p may be determined. This percentile index p may then be used to infer the likelihood or probability that the value of NTS arose by chance, which is the statistical significance of NTS.

The invention includes any manner of relating NTS to a numerical test statistic array of randomly generated results, including any manner of relating NTS to a percentile value P based on the numerical test statistic array. However, an exemplary embodiment of the invention is shown in steps 25 through 33 of FIG. 2b, which begins with initializing variable j to one at step 25. The computer then sorts the numerical test statistic array into ascending order at step 26, resulting in an ordered array OTS having the same dimensions and containing the same data as the test statistic array of step 22. However, with the array arranged in an incrementally sorted format, the computer is able to systematically compare the original numerical test statistic NTS with the randomly based numbers to determine its corresponding percentile value P and associated percentile index p.

This systematic comparison begins at decision diamond 27, which first compares the numerical value NTS with the smallest numerical value in the array of stored numerical test statistics, defined as OTS(1). If NTS is less than OTS(1), then it is known that NTS is smaller than the entire set of numerical test statistics corresponding to randomly generated data sets having the same size, dimension and distribution as the original data set. The computer determines that NTS is in the “zeroth” percentile, indicating that the original numerical test statistic NTS is an extreme data point beyond the bounds of the randomly generated values and, therefore that the chances of the event happening by chance under a two-tailed null hypothesis are very remote. The conclusion of the computerized evaluation therefore may be to reject the null hypothesis or to re-execute the program using a higher value N to potentially expand the randomly generated comparison set.

The computer outputs its results as shown in step 28, which include the percentile index zero, the corresponding percentile value P, and the numerical value NTS of the test statistic corresponding to the original data set. The invention contemplates any variation of data output at the final step, in any form compatible with the computer system. An embodiment includes an output to a monitor 4 or printer 5 of FIG. 1 that identifies the numerical value of the test statistic NTS derived from the original data set, the corresponding percentile index p relating to the likelihood of NTS arising by chance, and the number of random data sets N on which p is based. In this case of NTS being less than all randomly based test statistics, p would equal zero. This result may also be interpreted in terms of the null hypothesis of step 14; in the case of a two-tailed test, such an extreme value would lead to rejecting the null hypothesis, while in a one-tailed test this could lead to accepting the null hypothesis.

If at decision diamond 27 the computer determines that OTS(1) is not greater than NTS, it moves to decision diamond 29, which tests the other extreme. In other words, the computer determines whether NTS is larger than the highest value OTS(N) of the numerical test statistics corresponding to randomly generated data sets having the same size, dimension and distribution as the original data set of step 12. If the answer is yes, then the computer determines that NTS is in the “one hundredth” percentile, usually indicating that the null hypothesis should be rejected because the test statistic is statistically significant (i.e. not likely to have resulted from chance). The computer may also re-execute the program using a higher value N to potentially expand the randomly generated comparison set. In one embodiment, the previously obtained test statistic array would be augmented, not replaced, which also is true for the zeroth percentile case. The results are then output as described above and as provided in step 28 of FIG. 2b.

If NTS does not fall beyond either extreme, the computer moves to a repetitive loop, consisting of steps 31 through 33, which brackets NTS between two numerical test statistics arising from randomly generated data. First, the variable j is incremented by 1 at step 31. Then, at decision diamond 32, the computer determines whether the numerical value OTS(j) is larger than the numerical value NTS. If not, the computer returns to the beginning of the loop at step 31, as indicated by step 33, increments j by one, and again compares the numerical value OTS(j) with NTS. This process is repeated until OTS(j) is larger than NTS, which means that NTS falls between OTS(j) and OTS(j−1). The percentile value P and associated percentile index p therefore correspond to this positioning of NTS on the ordered array OTS of test statistic values corresponding to randomly generated data sets. If the difference between the two successive percentiles were greater than some amount, then a higher value of N might be specified, as described previously. Once this bracketed value is known, the computer proceeds to output the results.

The output of one embodiment would be a function of percentile indices. The percentile indices corresponding to the percentile values which bracket NTS are described as being between (j−1)/N×100 percent and j/N×100 percent. For example, if the repetitive loop of steps 31 through 33 determines that OTS(950) out of a set of 1000 numerical test statistics arising from respective randomly generated data sets is the lowest value of OTS(j) higher than NTS, then the value of NTS lies between the percentile values with indices 949/1000×100% and 950/1000×100%, or indices 94.9% and 95.0%, which allows the conclusion that 94.9%<P<95.0%, where P in this case refers to the probability rather than the percentile, although of course the two are closely related. Probability P is estimated by the percentile indices. As described above, this information regarding the value of probability P is output from the computer among other relevant data as shown in step 28.

The output probability P estimates the likelihood that the original numerical value of the test statistic might have arisen from random processes alone. In other words, the computer determines the “significance” of the original numerical test statistic NTS. For example, if the computer determines that NTS is within the 96^{th} percentile among the numerical ordered test statistic array OTS, it may be safe to conclude that it did not occur by chance, but rather has statistical significance in a one-tailed test (i.e. it is significant at the 4 percent level). Based on this information, the original hypothesis of step 14, whether it represents a prediction model or a relationship between two variables represented in the original data set, may be rejected.

FIG. 3 shows a related embodiment using the same theory regarding generation of a random data set of the same size and dimension as the original data set, defined at step 40 and collected at step 41, and distributed according to the distribution specified at step 45. Although the term “test statistic” is usually associated with hypothesis testing, this term will be retained in the discussion of confidence intervals in order to emphasize the essential similarity of the two procedures. As before, the term “test statistic,” specified in step 42, will be used to denote some function of the data to be found in the database, e.g., arithmetic mean, and will be used to subsume terms such as “estimator” and “decision function.” The initialization is identical to that shown in FIG. 2a, except instead of specifying a null hypothesis at step 14, the user specifies the size of the confidence interval at step 43, having ends of the interval defined as “Lo” and “Hi.” As a practical matter, the confidence interval specified at this step usually would be symmetrical of size 95 percent. This means that, in this mode, the disclosed invention will identify the two values of the test statistic between which the observed numerical value NTS of the test statistic is 95 percent likely to occur. The corresponding value of “Lo” is 0.025 and the corresponding value of “Hi” is 0.975 (which defines an interval of size 0.950, or a 95 percent interval).

After the confidence interval is specified, the disclosed invention continues as shown in FIGS. 2a-2b and described above. The numerical value of the test statistic is calculated at step 44, the distribution is specified in step 45, the number of iterations is specified at step 46 and an array of random data sets and the array of corresponding numerical values of the test statistic are generated in the repetitive loop of steps 48 to 53. In the disclosed embodiment, the numerical statistic array is then sorted at step 54 into ascending order to accommodate analysis of the numerical value of the statistic specified in step 42 and calculated in step 44.

Hereafter, the process is customized to the extent necessary to format usable and appropriate output from the computer. Steps 55 through 59 determine the numerical values defining the upper and lower endpoints of the desired confidence interval. At steps 55 and 56, the computer determines which two values of the ordered set OS to use in calculating the lower limit of the confidence interval, by multiplying Lo by N and identifying the greatest integer less than or equal to that product. That integer and its successor are used to identify the required values of OS, which are used to calculate the lower limit, called Low. Assuming that N was specified as 1000, with a symmetric 95 percent confidence interval, in the exemplary embodiment, the values of OS would be 0.025×1000=25, and the next higher value, 26. The lower endpoint of the confidence interval would be given by a function f of these two OS values, f(OS(25), OS(26)).

Similarly, at steps 57 and 58, the computer determines which two values of OS to use in calculating the upper limit of the confidence interval, by multiplying Hi by N and identifying the smallest integer greater than or equal to that product. That integer and its successor are used to identify the required values of OS, which are used to calculate the upper limit, called High. Again assuming N was specified as 1000 and the confidence interval is symmetrical, in the exemplary embodiment, the values of OS would be 0.975×1000, and its successor, 976. The upper endpoint of the confidence interval would be given by a function g of these two OS values, g(OS(975), OS(976)). Note that the functions f and g will depend on the current statistical practice and the philosophy of the developer, but will typically be functions such as maximum, minimum, or linear combination. As before, a decision may be made to increase N, or to use a function of more than the bracketing two percentiles and their respective indices. The final step of the confidence interval analysis is to output the relevant data, as shown in step 59.

While the invention as herein described is fully capable of attaining the above-described objects, it is to be understood that it is one embodiment of the present invention and is thus representative of the subject matter which is broadly contemplated, that the scope of the present invention fully encompasses other embodiments which may become obvious to those skilled in the art, and that the scope of the present invention is accordingly to be limited by nothing other than the appended claims. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

1. A method for testing validity of a prediction model based on an original data set, comprising:
specifying a test statistic formula;
computing a numerical value NTS of the test statistic using the test statistic formula and the original data set;
specifying a probability distribution relating to the original data set;
creating a plurality of random data sets RDB(i) using randomly generated data, in which i is a positive integer;
computing a plurality of numerical values TS(i) of the test statistic corresponding to the plurality of random data sets RDB(i), and storing each numerical value TS(i) in a numerical test statistic array; and
comparing the numerical value NTS with the numerical test statistic array to determine a non-empty set of percentile values corresponding to the numerical value NTS and an associated non-empty set of percentile indices.

2. The method for testing validity of a prediction model according to claim 1, in which each of the plurality of data sets RDB(i) is distributed according to the probability distribution.

3. The method for testing validity of a prediction model according to claim 2, in which each the data sets RDB(i) has a size that is functionally equivalent to a size of the original data set.

4. The method for testing validity of a prediction model according to claim 1, further comprising:
determining a null hypothesis defining a potential relationship among data in the original data set; and
rejecting the null hypothesis as not accurately representing the original data set when the value of a function of the non-empty set of percentile indices, associated with the non-empty set of percentile values, which correspond to the numerical value NTS, is in an extreme range, indicating that the numerical value NTS did not arise by chance.

5. The method for testing validity of a prediction model according to claim 1, in which the non-empty set of percentile values comprises the greatest percentile value less than NTS and the smallest percentile value greater than NTS, and the non-empty set of percentile indices comprises the two percentile indices corresponding to the two percentile values of the non-empty set of percentile values.

6. The method for testing validity of a prediction model according to claim 1, in which one percentile index is selected, when the corresponding percentile value meets a predetermined criterion for proximity to the numerical value NTS of the test statistic corresponding to the original data set.

7. The method for testing validity of a prediction model according to claim 4, in which the function of percentile indices is a linear combination of the non-empty set of percentile indices.

8. The method for testing validity of a prediction model according to claim 1, in which the test statistic comprises a function of prediction error.

9. The method for testing validity of a prediction model according to claim 4, in which the extreme range comprises one of above a 97.5^{th} percentile and below a 2.5^{th} percentile.

10. The method for testing validity of a prediction model according to claim 1, in which creating the plurality of random data sets RDB(i) comprises using randomly generated data according to a Monte Carlo technique.

11. The method for testing validity of a prediction model according to claim 1, further comprising constructing a confidence interval for the test statistic.

12. The method for testing validity of a prediction model according to claim 1, in which each of the plurality of data sets RDB(i) has the same size, dimension and distribution as the original data set.

13. A computing apparatus for analyzing an original data set, the original data set having a first size, dimension and distribution, the computing apparatus comprising:
a computing device for executing computer readable code;
an input device for receiving data, the input device being in communication with the computing device;
at least one data storage device for storing computer data, the data storage device being in communication with the computing device; and
a programming code reading device that reads computer executable code, the programming code reading device being in communication with the computing device;
the computer executable code causing the computing device to generate a plurality of random data sets, each random data set having a second size, dimension and distribution relating to the original data set; calculate a plurality of numerical values of test statistics corresponding to the plurality of random data sets, each numerical value being calculated according to a test statistic formula; and determine a relationship between the plurality of numerical values and the numerical value of the test statistic corresponding to the original data set, calculated in accordance with the test statistic formula.

14. The computing apparatus according to claim 13, in which the second size, dimension and distribution is the same as the first size, dimension, and distribution.

15. The computing apparatus according to claim 13, in which the second size of each random data set is functionally equivalent to the first size of the original data set.

16. The computing apparatus according to claim 13, in which the relationship between the plurality of numerical values and the numerical value corresponding to the original data set indicates whether the original data set is characterized by at least one factor that is not based on chance.

17. The computing apparatus according to claim 13, in which determining the relationship between the plurality of numerical values and the numerical value corresponding to the original data set comprises:
determining a plurality of percentile values, based on the plurality of numerical values, and a plurality of percentile indices corresponding to the plurality of percentile values; and
determining a non-empty set of selected percentile indices from the plurality of percentile indices, corresponding to the plurality of random data sets, by determining a non-empty set of percentile values from the plurality of percentile values which meets a predetermined criterion for proximity to the numerical value of the test statistic corresponding to the original data set.

18. The computing apparatus according to claim 17, the computer executable code further causing the computing device to select two percentiles indices, corresponding to the greatest percentile value less than the numerical value of the test statistic corresponding to the original data set, and the smallest percentile value greater than the numerical value of the test statistic corresponding to the original data set.

19. The computing apparatus according to claim 17, the computer executable code further causing the computing device to select one percentile index when the corresponding percentile value meets a predetermined criterion for proximity to the numerical value of the test statistic corresponding to the original data set.

20. The computing apparatus according to claim 17, the computer executable code further causing the computing device to determine that the numerical value of the test statistic corresponding to the original data set did not arise by chance when the value of a predetermined function of the selected percentile indices is outside a predetermined range of the plurality of percentile indices indicating numerical values that did arise by chance.

21. The computing apparatus according to claim 20, in which the predetermined function of percentile indices is a linear combination of the corresponding percentile indices.

22. The computing apparatus according to claim 13, in which the computer executable code further causes the computing device to construct a confidence interval for the test statistic.

23. The computing apparatus according to claim 13, in which generating the plurality of random data sets further comprises generating the random data sets according to a Monte Carlo technique.

24. A computer readable medium storing a computer program that determines a likelihood of at least one factor in an original data set not arising by chance, in accordance with a predetermined test statistic formula, the original data set having a first size, dimension and distribution, the program comprising:
a calculating source code segment that calculates a plurality of numerical values of test statistics corresponding to a plurality of randomly generated data sets, calculated in accordance with the predetermined test statistic formula, each randomly generated data set having a second size, dimension and distribution relating to the original data set;
a comparing source code segment that compares a numerical value of a test statistic calculated in accordance with the predetermined test statistic formula and calculated with the original data set, with the plurality of numerical values corresponding to the plurality of randomly generated data sets; and
a determining source code segment that determines that at least one factor in the original data set did not arise by chance when the numerical value of the test statistic calculated from the original data set is not within a range, within the plurality of numerical values corresponding to the plurality of randomly generated data sets, representative of numerical values arising by chance.

25. The computer readable according to claim 24, in which the second size, dimension and distribution is the same as the first size, dimension and distribution.

26. The computer readable according to claim 24, the program further comprising:
a percentile determining source code segment that determines a plurality of percentile values, based on the plurality of numerical values, and a plurality of percentile indices, corresponding to the plurality of percentile values;
wherein the comparing source code segment compares the numerical value of the test statistic corresponding to the original data set with the plurality of numerical values corresponding to the plurality of randomly generated data sets by determining a non-empty set of selected percentile indices from the plurality of percentile indices corresponding to the plurality of random data sets associated with a non-empty set of the percentile values from the plurality of percentile values which meets a predetermined criterion for proximity to the numerical value of the test statistic corresponding to the original data set.

27. The computer readable according to claim 26, in which the range of values is based on the plurality of associated percentile indices.

28. The computer readable according to claim 24, in which the second size of each randomly generated data set is functionally equivalent to the first size of the original data set.

29. The computer readable according to claim 27, in which the second size of each randomly generated data set is functionally equivalent to the first size of the original data set.

30. The computer readable according to claim 24, the program further comprising:
a distribution determining source code segment that determines the distribution of the original data set by comparing the original data set with a plurality of theoretical distributions.

31. The computer readable according to claim 24, the program further comprising:
a distribution determining source code segment that determines the distribution of the original data set by sorting the data into bins along at least one dimension.

32. The computer readable according to claim 24, in which the first distribution is not a normal distribution.

33. The computer readable according to claim 24, the program further comprising a confidence interval source code segment that constructs a confidence interval for the test statistic.

34. The computer readable according to claim 24, the program further comprising a distribution determining source code segment that determines an empirical distribution of the original data set.
